(19) United States
(12) Patent Application Publication
(10) Pub. No.: US 2025/0240651 A1
(43) Pub. Date: Jul. 24, 2025

(54) Methods and Systems for Predicting Incidents in a Network

(71) Applicant: T-Mobile Innovations LLC, Overland Park, KS (US)

(72) Inventors: Shawn ANDREWS, Celina, TX (US); Jasen VIRASAWMY, Frisco, TX (US); Michael WILBANKS, Prosper, TX (US)

(21) Appl. No.: 18/421,947

(22) Filed: Jan. 24, 2024

(51) Int. Cl. H04W 24/04; H04W 24/10

(52) U.S. Cl. CPC H04W 24/04; H04W 24/10

(57) ABSTRACT

A method comprises obtaining signature data associated with a network element using a predictive model based on historical radio access data describing a prior incident at the network element in the radio access network, wherein the signature data indicates a pattern of the historical radio access data associated with the prior incident at the network element, inputting current radio access data into the predictive model to obtain a prediction output based on the signature data, wherein the prediction output indicates data regarding a predicted incident at the network element, a predefined time period in which the predicted incident is likely to occur, and a preventative resolution to the predicted incident, and generating a service report indicating at least one of the predicted incident at the network element, the predefined time period, or the preventative resolution.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Communication network operators build systems and tools to monitor their networks, to identify network elements (NEs) that need maintenance, to assign maintenance tasks to personnel, and to fix NEs. Operational support systems (OSSs) may be provided by vendors of NEs to monitor and maintain their products. When trouble occurs in NEs, the OSS and/or the NEs may generate an alarm notification. An incident reporting system may be provided by the network operator to track incident reports which may be assigned to employees to resolve one or more pending alarms. A network operation center (NOC) may provide a variety of workstations and tools for NOC personnel to monitor alarms, close incident reports, and maintain the network as a whole. It is understood that operating and maintaining a nationwide communication network comprising tens of thousands of cell sites and other NEs is very complicated.

### SUMMARY

In an embodiment, a method for maintaining a communication network is disclosed. The method comprises collecting, by a prediction application executing on a computer system in the communication network, historical radio access data and historical incident data, each associated with prior incidents across a plurality of network elements in the radio access network, generating, by the prediction application, signature data associated with a network element using a predictive model based on the historical radio access data and the historical incident data. The signature data indicates a pattern identified in the historical radio access data and the historical incident data associated with a prior incident at the network element. The method further comprises obtaining, by the prediction application, current radio access data associated with the network element, and inputting, by the prediction application, the current radio access data into the predictive model to obtain a prediction output based on the signature data. The prediction output indicates data regarding a predicted incident at the network element, a predefined time period in which the predicted incident is likely to occur, and a preventative resolution to the predicted incident. The method further comprises generating, by the prediction application, a service report indicating at least one of the predicted incident at the network element, the predefined time period, or the preventative resolution to the predicted incident, instructing, by the prediction application, an automated system to perform the preventative resolution at the network element, and receiving, by a validation application executing on the computer system, feedback data regarding the predicted incident, in which the feedback data is used to update at least one of the signature data or the predictive model.

In another embodiment, a communications network implemented in a network comprising a radio access network is disclosed. The communications network comprises a prediction application and a validation application. The prediction application executes on a computer system in the communication network and is configured to use a predictive model to obtain signature data associated with a network element based on a historical radio access data describing a prior incident at the network element in the radio access network, in which the signature data indicates a pattern of the historical radio access data associated with the prior incident at the network element, and in which the signature data is based on correlations identified between different types of the historical radio access data associated with the prior incident at the network element. The prediction application is further configured to obtain current radio access data associated with the network element, input the current radio access data into the predictive model to obtain a prediction output based on the signature data, in which the prediction output indicates data regarding a predicted incident at the network element, a predefined time period during which the predicted incident is likely to occur, and a preventative resolution to the predicted incident, generate a service report indicating at least one of the predicted incident at the network element, the predefined time period, or the preventative resolution, and transmit the service report to a processing entity for resolution. The validation application executes on the computer system and is configured to update at least one of the signature data or the predictive model based on feedback data describing an accuracy of the prediction output.

In yet another embodiment, a method for maintaining a communication network by predicting incidents in a radio access network of the communication network is disclosed. The method comprises obtaining, by a prediction application executing on a computer system in the communication network, signature data associated with a network element using a predictive model based on historical radio access data describing a prior incident at the network element in the radio access network. The signature data indicates a pattern of the historical radio access data associated with the prior incident at the network element, and the signature data is based on correlations identified between different types of the historical radio access data associated with the prior incident at the network element. The method further comprises obtaining, by the prediction application, current radio access data associated with the network element, and inputting, by the prediction application, the current radio access data into the predictive model to obtain a prediction output based on the signature data. The prediction output indicates data regarding a predicted incident at the network element, a predefined time period in which the predicted incident is likely to occur, and a preventative resolution to the predicted incident, wherein the preventative resolution comprises one or more corrective actions to prevent the predicted incident from occurring. The method further comprises generating, by the prediction application, a service report indicating at least one of the predicted incident at the network element, the predefined time period, or the preventative resolution, transmitting, by the prediction application, the service report to a processing entity for resolution, receiving, by the prediction application, feedback data regarding the predicted incident, and updating, by a validation application executing on the computer system, at least one of the signature data or the predictive model based on the feedback data.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to various embodiments of the disclosure.

FIGS. 2A, 2B, 20, 2D, and 2E are block diagrams illustrating various embodiments of predicting incidents in the communication network of FIG. 1 according to various embodiments of the disclosure.

FIG. 3 is a block diagram illustrating examples of data used to predict incidents in the communication network of FIG. 1 according to various embodiments of the disclosure.

FIG. 4 is a flow chart of a method according to an embodiment of the disclosure.

FIG. 5 is a flow chart of another method according to an embodiment of the disclosure.

FIG. 6A and FIG. 6B are block diagrams of a 5G network according to an embodiment of the disclosure.

FIG. 7 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

A communications network may include one or more radio access networks (RANs), each including network elements (NEs) used to transport traffic between a source and destination. The NEs may include, for example, routers, virtual private networks (VPNs), cell sites, towers, macro/micro cells, etc. The communication network may also include an incident reporting system, which may include, for example, one or more OSSs, central monitoring station(s), incident reporting applications, and/or incident management applications, that work together to monitor and resolve hardware and software incidents (e.g., failures and faults) that may occur at the NEs in the system. For example, each of the NEs in the region may be subject to different types of equipment incidents, which result in the triggering of alarms that are picked up by OSSs. The alarms may be propagated upwards to an incident reporting application, which may be responsible for automatically or manually generating an incident report detailing the incident that caused the alarm. The incident reporting application may create the incident report and send the incident report to an incident management application, which may be responsible for triaging the incident report and ensuring that the incident report is sent to the proper entity for resolution of the incident described in the incident report.

For example, cell sites in a RAN may be susceptible to different types of incidents caused by hardware and software failures, which may impact the overall performance of the network. Hardware failures may include, for example, circuit card failures, antenna failures, power supply failures, backhaul link failures, cable failures, temperature related failures, etc. Software failures may include, for example, firmware bugs, software configuration errors, database corruption, software update issues, security vulnerabilities, protocol stack failures, etc. The NEs in the RAN, or an application communicatively coupled to the NEs, may be programmed to detect these incidents or conditions leading up to these incidents and trigger an alarm accordingly. An incident report may then be created based on the incident that triggered the alarm. The incident report may be, for example, forwarded to an automated system, a NOC operator, or a field technician for resolution (i.e., correcting the underlying incident that triggered the alarm and closing the incident, to complete the process of addressing and resolving the incident).

However, the alarms triggered at the NEs that are processed into incident reports may describe incidents that resulted in an actual failure or break in the network. That is to say, the alarms that trigger the creation of incident reports are reactive in nature, being created and processed only upon an incident occurring in the network that is significant enough to cause a failure in the network (e.g., an outage, fault, disconnection, crash, degradation of service, abnormal conditions, etc.). Therefore, while the programming of alarms in the incident reporting system described herein indeed results in the correction or fixing of the failure that caused the alarm, ultimately, the network may still have to experience these failures and outages before any corrective action is taken.

In this way, reactively responding to the alarms triggered by the NEs after the failure has already occurred in the network gives rise to various technical problems. For example, the resulting failures significantly decrease network capacity, at least until the failure can be resolved at the NE. Moreover, the reactive nature of correcting the incidents is far more resource intensive in that more detailed communications regarding the failure may be communicated through the network to multiple entities for resolution. In addition, it may be more difficult to automate the resolution of reactive corrections to the incident in a timely manner without some sort of human involvement (e.g., sending a technician to the field, involving a NOC operator to select the most efficient path to resolution, etc.).

The present disclosure teaches a technical solution to the foregoing technical problem related to network operations and maintenance by implementing methods and systems for predicting incidents in a network and ultimately resolving the incidents before a failure occurs in the network. As further described herein, the predictions may be performed using a predictive model, which may have been trained using incident-related data obtained from thousands, if not millions, of NEs across numerous RANs. This vast amount of incident-related data collected over time may be analyzed as described herein to identify patterns and trends, and determine signature features that predict the occurrence of an incident across one or more NEs. These determined signatures may be used to predict and prevent future incidents across multiple NEs at various points in time. The predictive model may be trained over time based on the predicted data and feedback data related to an accuracy of the predicted data to enhance the accuracy of the predictive model over time. In this way, the predicted and prevent incidents described herein are based on an enormous amount of data points (which may not conceivably be performed by a human or simple processor), and this amount of data being analyzed for purposes of prediction contributes the accuracy of the predictions made by the embodiments disclosed. Nevertheless, by detecting and preventing the incidents in the network prior to the incident actually occurring, the methods and systems disclosed herein prevent outages and abnormalities from occurring at the NEs, thereby significantly increasing network capacity and reduce the load on the network.

In an embodiment, a prediction system may be introduced in the incident reporting system. The prediction system may be a server or computer system in the incident reporting system. The prediction system may include and be based on a predictive model. The predictive model may be a computational system (e.g., including both software and hardware components) designed to make predictions or forecasts based on patterns learned from historical data. The predictive model may be implemented using software (e.g., algorithms, logic, and code) stored across one or more memories, and the underlying hardware of the predictive system may provide the computational resources for execution of the predictive model. For example, the predictive model may be a type of machine learning model that leverages algorithms and statistical techniques to analyze input features and identify patterns and generate predictions about future incidents in the RAN. The predictive model may be implemented as one or more different types of models using, for example, linear regression, decision trees, support vector machines, neural networks, or ensemble methods. It should be appreciated that any type of predictive model may be used, and the underlying algorithms, computations, and machine learning libraries used by the predictive model should not be limited herein.

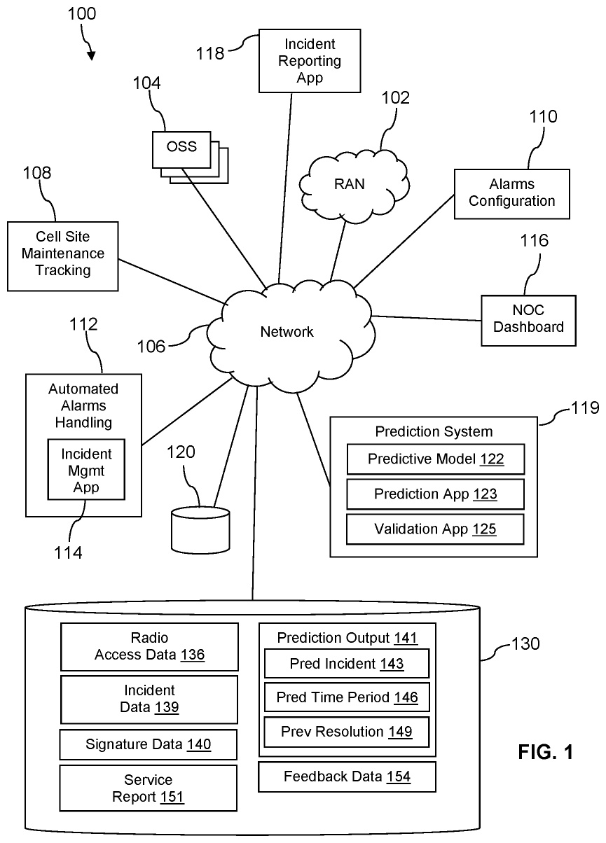

The prediction system may also include a prediction application that uses the predictive model to predict incidents at the RAN based on historical data, which may include various types of data that may be cross-correlated to identify patterns and trends for the purpose of incident prediction. The historical data used to predict the incidents may include, for example, radio access data. For example, the radio access data may include performance data, fault management data, and event logs from OSS platforms. The performance data may refer to information related to the use and performance of the NEs in the RAN of the communication network. The fault management data may refer to information collected and utilized by the incident reporting system that is used to detect and manage the faults and issues within the RAN. For example, the fault management data may include data related to the various types of alarms programmed across the NEs in the RAN. The event logs may refer to the information detected and maintained by each of the NEs in the RAN, which may have been recorded and logged by the NEs in response to detected system behaviors or error conditions. Additional examples of performance data, fault management data, and event log data is further described herein with reference to FIG. 1.

The historical data used to predict the incidents may also include, for example, incident data. The incident data may include information indicating the alarms that actually triggered the creation of incident reports by the incident reporting system. For example, the incident data may include data describing an identifying one or more alarms (and the incident that resulted in the triggering of the alarm at the NE), the NEs across which the alarm was triggered, the correspondingly generated incident report, and one or more corrective actions or resolution plans taken that either successfully or unsuccessfully resolved the incident that triggered the alarm. The incident data may include details included with the alarm and the incident report, which may have been used by the NOC to quickly respond to and address the incident.

The prediction application, or another monitoring application in the incident reporting system, may collect and store the radio access data and the incident data into a data store of the system over time, such that the data store maintains a history of the radio access data and the incident data of all of the NEs in the RAN. The radio access data and the incident data may thus include data describing the conditions and events related to prior incidents occurring at the NEs in the RAN.

In an embodiment, the prediction application may cross-correlate the historical data (e.g., the radio access data and the incident data) using the predictive model to obtain signature data indicating signature features that may be indicative that a particular type of incident is likely to occur in the future across one or more NEs. The signature data may indicate a pattern of the radio access data and/or incident data associated with a prior incident at an NE.

For example, the incident data may indicate that a number of sleepy cell incidents occurred across one or more cell sites in the past, and may indicate the conditions of the cell site for a predefined time period before the cell site was deemed a sleepy cell and before the incident report for the sleepy cell was created. The prediction application may use the predictive model to analyze this incident data and determine patterns of conditions at the cell site before the cell site becomes a sleepy cell and while the cell site is a sleepy cell to generate signature data associated with a sleepy cell. As another example, the radio access data for these sleepy cells may also include steadily decreasing counts (e.g., dropped call counts, access failure counts, outage counts) up to the time the cell site was deemed a sleepy cell and before the incident report for the sleepy cell was created. The prediction application may use the predictive model to analyze this radio access data to determine patterns of these counts at the cell site before the cell site becomes a sleepy cell and while the cell site is a sleepy cell to generate the signature data associated with a sleepy cell.

In an embodiment, the prediction application may also use the predictive model to cross-correlate the radio access data with the incident data to further define the signature data for the particular type of incident. For example, the prediction application may use the predictive model to cross-correlate the radio access data with the incident data across numerous, maybe even thousands or millions of recorded prior sleepy cells in the RAN to identify patterns of behaviors and conditions that led up to the occurrence of the sleepy cell. The prediction application may analyze this vast amount of incident data to identify to identify patterns and generate a single set of signature data for the sleepy cell.

It should be appreciated that the prediction application may also use the predictive model to cross-correlate different types of data from other types of sources to identify these patterns and further refine the signature data for a particular type of incident. That is to say, the types of data used by the prediction application and the predictive model should not be limited to radio access data and the incident data, but instead should encompass other types of data related to the incidents in the RAN and not explicitly described herein.

The signature data may be specific for an NE, specific of types of NEs, locations of the NEs, software versions running on the NEs, etc. The signature data may indicate signature features indicative of an incident likely to occur at a single NE, at multiple NEs within a geographical range, at NEs that use a particular type of software, etc. For example, the signature data for a cell site associated with or manufactured by a first vendor may not be compatible with the signature data for another cell site associated with or manufactured by a second vendor. In this case, the signature data may be specific for specific types of NEs associated with or manufactured by a specific vendor.

Once the prediction application has generated signature data for various types of incidents that may occur at the NE, the prediction application may use the predictive model to predict future incidents based on live or current radio access data associated with one or more NEs. To this end, the prediction application may obtain current radio access data associated with a NE. The prediction application may receive the current radio access data from the NEs after the NEs have detected the current radio access data. Alternatively, the prediction application may monitor and detect the current radio access data of the NEs in the RAN continuously or according to a predetermined scheduled/time interval. In either case, the prediction application may obtain the current radio access data and use the current radio access data to predict whether an incident may occur in the future at the RAN using the predictive model.

The prediction application may input the current radio access data into the predictive model to obtain a prediction output based on the signature data. The predictive model may use the signature data, along with the encoding and logic of the machine learning model itself, to generate a prediction output. The prediction output may indicate whether the current radio access data is indicative of a predicted incident, or a potential future incident at the NE. The predictive incident may correspond to a specific incident or type of incident (i.e., outage, fault, failure, abnormality, etc.) that has previously occurred at one or more NEs in the RAN. The prediction output may also indicate a predefined time period in the future during which the predicted incident may be likely to occur. For example, the predefined time period may be anywhere within the next 1 to 96 hours of obtaining the current radio access data. The prediction output may also in some cases indicate a preventative resolution that may be used to prevent the predicted incident from actually occurring. The preventative resolution may indicate one or more corrective actions, which may have been performed (a certain number of times) in the past and successfully resolved in the incident in those instances.

In an embodiment, the prediction output further comprises a confidence score associated with the predicted incident at the NE. The confidence score may be a value, proportion, or percentage indicating a level of certainty that the predicted incident has been predicted accurately and completely. The prediction application may determine the confidence score based on a history of the predictive model successfully predicting prior incidents similar to the predicted incident at other NEs in the RAN. In some cases, when the confidence score is above a preset threshold value, the prediction application may determine that the prediction output indicates that an incident is likely to occur at the NE in the near future. In contrast, when the confidence score is less than or equal to a preset threshold value, the prediction application may determine that the prediction output indicates that an incident is not likely to occur at the NE in the near future.

When the prediction output indicates the likelihood of an incident occurring at the NE in the near future, the prediction application may generate a service report. The service report may indicate the data from the prediction output (e.g., the predicted incident, the predefined time period, and/or the preventative resolution). The service report may also include the current radio access data that triggered the prediction output and conditions around the current radio access data (e.g., data defining the NEs associated with the current radio access data, time of obtaining the current radio access data, etc.). The service report may also possibly include the historical data (e.g., the radio access data and the incident data) and/or the signature data that was used by the predictive model to generate the prediction output.

In an embodiment, the prediction application may transmit the service report to a processing entity for resolution. The processing entity may be an automated system, which may be programmed to automatically perform the corrective actions indicated in the preventative resolution of the prediction output. The automated system may also be programmed to perform a series of corrective tasks, according to a particular order, in an attempt to automatically provide services to the NE to prevent the predicted incident from actually occurring at the NE. Alternatively, the processing entity may be an operator at the NOC or a field technician at the field, either of which may be able to address the predicted incident indicated in the service report to provide services to the NE to prevent the predicted incident from actually occurring at the NE, and close the service report.

In some cases, the predictive model is continuously trained, refined, and re-evaluated over time for performance and accuracy, using feedback data and validation methods. To this end, the prediction system may additionally include a validation application that may obtain and provide feedback data back to the predictive model to continuously refine and train the predictive model for accuracy and completeness. For example, the validation application may be initially responsible for training the predictive model with training data. The training data may include combinations of known historical data (e.g., known radio access data and incident data), known signature data, and corresponding outcomes (e.g., known prediction outputs). For example, the validation application may continuously feed the predictive model with training data, and compare the actual output of the predictive model with the known prediction output to obtain feedback data describing an accuracy of the predictive model in predicting the known prediction output. The feedback data may also include data that may assist the predictive model in further refining the computations and data points in the predictive model based on the comparison indicating the accuracy of the predictive model. Once the predictive model is trained to a certain degree, the predictive model may then be used to generate prediction outputs based on current situations in the RAN.

Subsequently, the predictive model may be continuously trained and further refined for accuracy. The prediction application may obtain feedback data from various different sources regarding an accuracy of the prediction output, and update the signature data and/or the predictive model accordingly. For example, the prediction application may receive feedback data from the NOC or from another monitoring application in the system indicating whether the time period indicated in a prediction output for a predicted incident was indeed accurate or not. When the time period is not accurate, the inaccuracy may be indicated in feedback data and provided back to the predictive model to regenerate signature data if needed and/or use the inaccuracy as another data point in the predictive model.

Similarly, the NEs in the RAN may be periodically reconfigured with updated RAN and incident data, such as, for example, new radio access data and new incident data. For example, the NEs in the RAN may be periodically reconfigured, the reconfiguration of which may be detected or monitored by the prediction application and stored as updated RAN and incident data. The prediction application may similarly update the predictive model based on the updated RAN and incident data, to regenerate signature data if needed and/or use the updated RAN and incident data as another data point in the predictive model used.

Therefore, the embodiments of detecting and preventing the incidents in the network prior to the incident actually occurring in the network serves to significantly increase network capacity and reduce the load on the network. For example, by ultimately and ideally preventing incidents such as outages, failures, faults, and other abnormalities in the RAN, the NEs in the RAN are enabled to continue operating normally, forwarding traffic as expected and providing services to customers as expected. This in turn prevents NEs in the RAN from crashing and prevents customers from experiencing the results of the crashing, such as, for example, dropped calls and access failures. In addition, the embodiments disclosed herein enable the automation of more accurate preventative resolution plans, as opposed to merely processing the NE through a series of pre-determined automated steps for resolution, without considering the specific type of incident that may occur at the RAN.

Turning now to FIG. 1, a communication network 100 is described. In an embodiment, the communication network 100 comprises a radio access network (RAN) 102, a plurality of operational support systems (OSSs) 104, a network 106, a cell site maintenance tracking system 108, an alarms configuration system 110, an automated alarms handling system 112 that executes an incident management application 114, a network operation center (NOC) dashboard system 116, an incident reporting application (or system) 118, and a data store 120. In an embodiment, communication network 100 may be a telecommunications carrier networking comprising the RAN 102.

The RAN 102 comprises a plurality of NEs, such as, for example, cell sites and backhaul equipment. In an embodiment, the RAN 102 comprises tens of thousands or even hundreds of thousands of cell sites. The cell sites may comprise electronic equipment and radio equipment including antennas. The cell sites may be associated with towers or buildings on which the antennas may be mounted. The cell sites may comprise a cell site router (CSR) that couples to a backhaul link from the cell sites to the network 106. The cell sites may provide wireless links to user equipment (e.g., mobile phones, smart phones, personal digital assistants, laptop computers, tablet computers, notebook computers, wearable computers, headset computers) according to a 5G, a long-term evolution (LTE), code division multiple access (CDMA), or a global system for mobile communications (GSM) telecommunication protocol. In an embodiment, the OSSs 104 comprises tens or even hundreds of OSSs. The network 106 comprises one or more public networks, one or more private networks, or a combination thereof. The RAN 102 may from some points of view be considered to be part of the network 106 but is illustrated separately in FIG. 1 to promote improved description of the network 100.

The cell site maintenance tracking system 108 is a system implemented by one or more computers. Computers are discussed further hereinafter. The cell site maintenance tracking system 108 is used to track maintenance activities on NEs (e.g., cell site equipment, routers, gateways, and other network equipment). When a NE is in maintenance, alarms that may occur on the NE may be suppressed, to avoid unnecessarily opening incident reports related to such alarms that may be generated because of unusual conditions the equipment may undergo pursuant to the maintenance activity. When a maintenance action is completed, maintenance personnel may be expected to check and clear all alarms pending on the subject NE before the end of the time scheduled for the maintenance activity.

The alarm configuration system 110 is a system implemented by one or more computers. The alarm configuration system 110 allows users to define rules and instructions for handling alarms, for example rules for automatic processing of alarms by the automated alarms handling system 112. The alarm configuration system 110 may define rules for when an alarm leads to automatic generation of an incident report, as described herein.

Alarms are flowed up from NEs of the RAN 102 via the OSSs 104 to be stored in the data store 120. The NOC dashboard 116 can access the alarms stored in the data store 120 and provide a list of alarms on a display screen used by NOC personnel. NOC personnel can manually open incident reports on these alarms. In an embodiment, the NOC dashboard 116 provides a system that NOC personnel can use to monitor health of a carrier network (e.g., monitor the RAN 102 and at least portions of the network 106), to monitor alarms, to drill down to get more details on alarms and on NE status, to review incident reports, and to take corrective actions to restore NEs to normal operational status. The NOC dashboard 116 may interact with the data store 120, with the cell site maintenance tracking system 108, the OSSs 104, the RAN 102, and other systems. NOC personnel can use the NOC dashboard 116 to manually create incident reports based on alarms reviewed in a user interface of the NOC dashboard 116.

The incident reporting application (or system) 118 can monitor the alarms stored in the data store 120 and automatically generate incident reports on these alarms based in part on the alarm configurations created and maintained by the alarms configuration system 110. For example, an alarm configuration rule defined by the alarm configuration system 110 may indicate that an incident report is not to be opened related to a specific alarm until the alarm has been active for a predefined period of time, for example for five minutes, for ten minutes, for fifteen minutes, for twenty minutes, for twenty-five minutes, or some other period of time less than two hours. The time criteria for auto generation of incident reports may be useful to avoid opening and tracking incidents that are automatically resolved by other components of the network 100, as described further hereinafter. Incident reports may be referred to in some contexts or by other communication service providers as tickets or trouble tickets.

The incident management application 114 may operate upon incident reports in a sequence of processes. In an embodiment, the incident management application 114 may perform automated triage on incident reports that includes automated enrichment of alarms and/or incident reports, automated dispatch to field operations personnel for some incident reports, and automated testing. Automated enrichment may comprise looking-up relevant information from a plurality of disparate sources and attaching this relevant information to the incident report. The looked-up information may comprise local environmental information such as weather reports, rainfall amounts, temperature, wind. The looked-up information may comprise logs of recent maintenance activities at the affected NE.

The automated triage process may involve determining a probable root cause for the incident and adding this to the incident report during the enrichment action. The probable root causes may be categorized as related to electric power, backhaul (e.g., transport), maintenance, or equipment (e.g., RAN hardware related), but within these general categories it is understood there may be a plurality of more precise probable root causes. The automated triage process can assign an incident report to personnel for handling based on its determination of the probable root cause of the incident report.

In an embodiment, the incident management application 114 may automatically close an incident report when NE status warrants such automated closure. Automated closure may happen because NOC personnel have taken manual corrective action to restore proper function of one or more NEs. Automated closure may happen because the incident management application 114 determines that the incident report was created pursuant to a maintenance action that extended beyond the scheduled maintenance interval and that the scheduled maintenance interval was later extended, but extended after a related incident report had already been generated. The incident management application 114 may perform automated remediation of alarm conditions associated with incident reports. For example, cell sites can be reset to restore operation and clear alarmed conditions. For example, cell sites can be locked and unlocked to restore operation and clear alarmed conditions. For example, cell sites may be resynched with GPS. For example, a software or firmware update may be pushed to cell sites.

In an embodiment, the communication network 100 may be enhanced to predict incidents and preventative resolutions to the predicted incidents in the RAN 102. To this end, the communication network 100 may include a prediction system 111 and a data store 130, as shown in FIG. 1. The prediction system 119 may be implemented as a server or computer system, including one or more processors and memories storing instructions. The prediction system 119 may include a predictive model 122, a prediction application 123, and validation application 125. The predictive model 122, prediction application 123, and validation application 125 may each correspond to instructions, which when executed by the processors of the prediction system 119, may be configured to perform the steps disclosed herein.

As mentioned above, the predictive model 122 may be a machine learning model that leverages algorithms and statistical techniques to analyze input features and identify patterns and generate predictions about future incidents in the RAN. In an embodiment, the predictive model 122 may receive historical data (e.g., radio access data 136 and incident data 139) as input, and then may output signature data 140. In another embodiment, the predictive model 122 may receive current radio access data describing a state, condition, or event occurring at an NE in the RAN 102, and may output a prediction output 141. The prediction output 141 may include a predicted incident 143, a predicted time period 146, a preventative resolution 149, and/or other data related to the predicted incident 143.

The prediction application 123 may obtain the data to be used as input (e.g., radio access data 136 and/or incident data 139) into the predictive model 122, receive the output (e.g., signature data 140 and/or the prediction output 141) of the predictive model 122, and further process the output of the predictive model 122. The prediction application 123 may also be used to generate the service reports 151 based on the prediction outputs 141.

The validation application 125 may obtain and provide feedback data 154 back to the predictive model 122 to further refine the predictive model 122 and/or update the signature data 140 defining various types of predicted incidents 143. The validation application 125 may be responsible for initially training the predictive model 122 with known data, and then continuously updating the predictive model 122 as feedback data 154 regarding the accuracy of the predictive model 122 is received. The validation application 125 may also be responsible for updating the predictive model 122 and/or the signature data 140 based on changes to the configurations of the NEs in the RAN 102, changes to the RAN 102 itself, and/or updates to the alarms and incident reports in the system. For example, the validation application 125 may update the predictive model 122 and/or the signature data 140 based on newly programmed alarms at the NEs in the RAN 102, newly processed incident reports at the system, changes to the architecture of the RAN 102, etc.

The data store 130 may store the inputs and outputs of the predictive model 122. The data store 130 may store the radio access data 136, incident data 139, signature data 140, prediction outputs 141, service reports 151, and the feedback data 154. The radio access data 136 may include, for example, performance data, fault management data, and event logs.

The performance data may refer to information related to the use and performance of the NEs in the RAN 102 of the communication network. The RAN 102 may be a component of a carrier network that connects mobile devices to the core network through radio signals. The performance data provides insights into the quality of service and efficiency of the RAN 102. For example, the performance data may include data describing the call drops, or the number of dropped calls in which a call is terminated prematurely, possibly due to poor signal quality, interference, or other network issues. The performance data may include data describing access failures, which may occur when a mobile device attempts to establish a connection with the RAN 102 but is unable to do so. Other types of the performance data may include signal strength measurements, handover events, network utilization metrics, load balancing metrics, interference levels, quality of service (QOS) metrics, service outages, etc. In some cases, the performance data may be formatted or encoded as a numerical value, or a counter, signifying a count of a specific event occurring or a condition existing across one or more NEs in the RAN 102 (e.g., a dropped call count, a service outage count, etc.).

The fault management data may refer to information collected and utilized by the incident reporting system that is used to detect and manage the faults and issues within the RAN 102. For example, the fault management data may include data related to the various types of alarms programmed across the NEs in the RAN 102. Each NE in the RAN 102 may be configured to trigger the creation and sending of certain types of alarms in response to the detection of an incident (e.g., condition, state, fault, or failure). The different types of alarms may be based on, for example, whether the incident is being observed before a failure occurs at the NE or whether the incident has been detected during or after a failure occurs at the NE. The different types of alarms may also be based on, for example, the NE detecting changes to the status or operation of the NE. For example, a cell site may be triggered to send a warning or minor alarm when a power level of the cell site falls below a threshold (i.e., before a failure occurs at the NE), and the cell site may be triggered to send a major alarm when a complete loss of power occurs at the cell site (i.e., after a failure occurs at the NE). As mentioned above, the NE may not be programmed to forward all of these alarms to the incident reporting application 118. However, the data store 130 may store the triggered alarms and the associated detected status change, condition, or event that triggered the alarm as part of the fault management data in the radio access data 136.

The event logs may refer to the information detected and maintained by each of the NEs in the RAN, which may have been recorded and logged by the NEs in response to detected system behaviors or error conditions. These event logs may also include data related to the status change, condition, or event that triggered an alarm at the NE, or other indicators of abnormal behavior. The event logs may also keep a record of normal operating behavior of the NE. In this way, the event logs of an NE may include records of all types of actions, behaviors, events, detected conditions, status changes, etc., that may have occurred or existed at the NE, and each record may be associated with a time or time range.

The incident data 139 may include, for example, data regarding the different alarms configured at the NEs in the RAN 102 and/or data regarding incident reports that have been processed by the system. The signature data 140 may be information indicating the patterns identified in various types of data input into the predictive model 122, such as, for example, the radio access data 136 and/or the incident data 139. The patterns in the signature data 140 may correspond to signature features indicative that an incident is likely to occur across one or more NEs in the RAN 102. The prediction output 141 may include an indication of the predicted incident 143, the predicted time period 146, and/or a preventative resolution 149. The predictive incident 143 may correspond to a specific type of incident (i.e., outage, fault, or failure) that has previously occurred at one or more NEs in the RAN 102. The predicted time period 146 may indicate a time period in the future in which the predicted incident 143 may be likely to occur. The preventative resolution 149 may indicate one or more corrective actions that may be performed at the NE now to potentially prevent the predicted incident 143 from occurring, which has been performed (a certain number of times) in the past that successfully resolved in similar prior incidents. When the preventative resolution 149 is performed, the incident associated with the prediction output 141 may be considered successively resolved and closed.

The service report 151 may be a report generated by the prediction application 123. The service report 151 may include the data from the prediction output 141, the current radio access data that triggered the prediction output 141 and conditions around the current radio access data (e.g., data defining the NEs associated with the current radio access data, time of obtaining the current radio access data, etc.), and/or other data that was used by the predictive model 122 to generate the prediction output 141. The feedback data 154 may be received by the validation application 125, for example, from users, operators, internal applications, or even external applications. The feedback data 154 may indicate an accuracy of the prediction output 141. In other words, the feedback data 154 may indicate whether the predicted incident 143 was accurate in the sense that the predicted incident 143 would have indeed happened if corrective action was not taken. The feedback data 154 may also indicate whether the predicted time period 146 for the predicted incident 143 was accurate or inaccurate. The feedback data 154 may also indicate whether the preventative resolution 149 correctly indicated accurate corrective actions that indeed prevented the predicted incident 143 from occurring or whether the preventative resolution 149 was unable to prevent the predicted incident 143 from occurring.

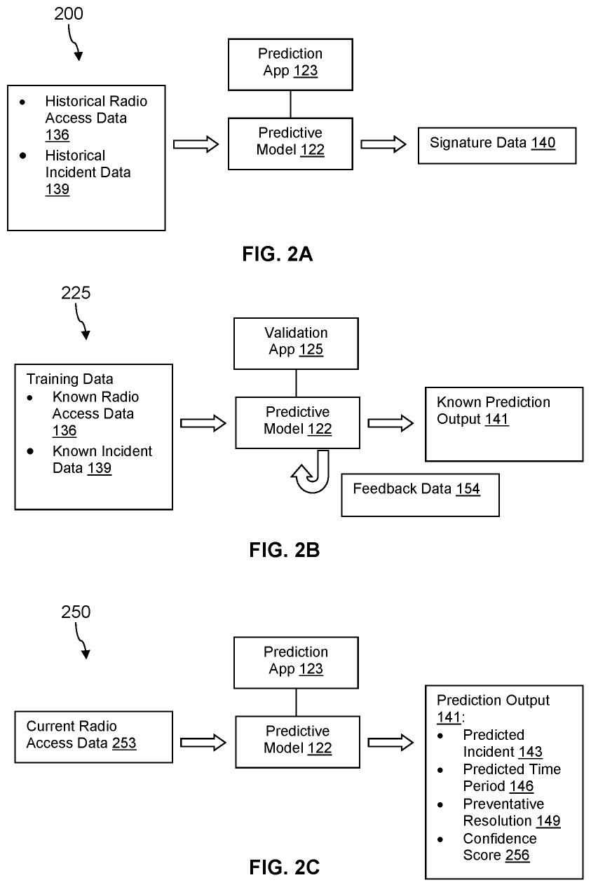

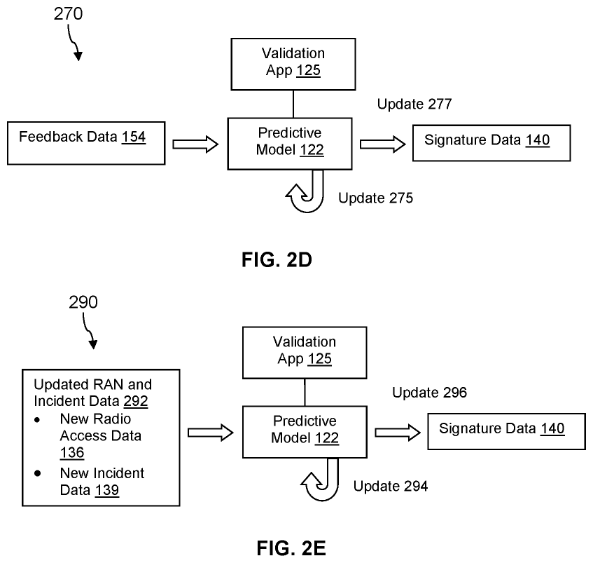

Referring now to FIGS. 2A-2E, block diagrams illustrating various embodiments of training, using, and updating the predictive model 122 are described. Turning now specifically to FIG. 2A, shown is a block diagram illustrating a method 200 of obtaining (e.g., generating) signature data 140. As shown in FIG. 2A, different types of historical data (e.g., historical radio access data 136 and historical incident data 139) may be provided as input into the predictive model 122, such that the predictive model 122 outputs the signature data 140. The historical data provided as input into the predictive model 122 may include other types of data as well, including data received from a variety of different sources, so long as the data relates to the maintenance of the NEs in the RAN 102.

The prediction application 123 may collect the historical radio access data 136 and the historical incident data 139 across one or more of the NEs in the RAN 102, which may sometimes include thousands or millions of data entries. The predictive model 122 may be programmed to process the vast amount of data entries and to intelligently cross-correlate the different types of data to identify patterns and trends across the different types of data. This cross-correlation may be performed, for example, based on identifications of the NEs, times of certain incidents, similarities and differences between NEs, similarities and differences between different types of incidents, the types of resolutions and corrective actions taken that either successfully or unsuccessfully resolved the incidents, etc.

The signature data 140 may indicate the patterns and trends identified by the predictive model 122. For example, the signature data 140 may be different for different types of predicted incidents 143, or the signature data 140 may be similar for predicted incidents 143 within a common category, but may be different for predicted incidents 143 within different categories. The signature data 140 may be different for different NEs or different types of NEs with different characteristics. The signature data 140 may be similar for NEs within a certain geographical range of one another, or the signature data 140 may be different regardless of the location of the NEs.

For example, the signature data 140 may indicate that for a particular NE, a type of NE or a category of NEs, or NEs within a certain geographic area, there is a pattern or trend of detected radio access data 136 that, when detected, signals the likelihood of a certain type of predicted incident 143 at the NE. In some cases, the signature data 140 may indicate that the pattern or trend of detected radio access data 136, when detected, signals the likelihood of multiple different predicted incidents 143 at the NE. The signature data 140 may indicate that this pattern or trend of detected radio access data 136, if detected, may result in the predicted incident 143 occurring within a predefined time period 146. The signature data 140 may also indicate that this pattern or trend of detected radio access data 136, if detected, may be successfully prevented from occurring by one or more corrective action steps.

Turning now specifically to FIG. 2B, shown is a block diagram illustrating a method 225 of training the predictive model 122. As mentioned above, the predictive model 122 may initially be programmed with one or more different types of models, such as, for example, linear regression, decision trees, support vector machines, neural networks, or ensemble methods, used to generate the signature data 140 and the prediction outputs 141 described herein. In an embodiment, the validation application 125 may first train the predictive model 122 using known training data and known outcomes to build the baseline foundation of the predictive model 122, such that the predictive model 122 may be accurately used to make predictions accordingly. The training data may include various combinations of known radio access data 136 and known incident data 139, which may be previously known to be associated with a particular type of incident (i.e., known prediction output 141). In some cases, the training data may also include known signatures related to a particular type of incident. This information may be provided to the predictive model 122 by the validation application 125 to train the predictive model 122 to correlate similar types of data according to the known signatures and to predict similar prediction outputs 141 based on the known signatures and the known incidents corresponding to those signatures.

In some cases, the validation application 125 may generate feedback data 154 based on an accuracy of the prediction model 122 in outputting the known prediction output 141. The feedback data 154 includes information that may be used to access a performance of the predictive model 122 and guide improvements to the predictive model 122. For example, the feedback data 154 may include a separate data set, validation or test data set, which may have known input features and outcomes, and which may again be used to continue refining the algorithms and computations in the predictive model 122.

Turning now specifically to FIG. 2C, shown is a block diagram illustrating a method 250 of using the predictive model 122 to predict incidents before the incident actually occurs in the RAN 102. The prediction application 123 may obtain current radio access data 253 associated with the NEs in the RAN 102. As mentioned above, the prediction application 123 may receive the current radio access data 253 from the NEs, after the NEs have detected the current radio access data 253. Alternatively, the prediction application 123 may monitor and detect the current radio access data 253 of the NEs in the RAN 102 continuously or according to a predetermined scheduled/time interval. In either case, the prediction application 123 may provide the the current radio access data 253 as input into the predictive model 122. The predictive model 122 may execute using the current radio access data 253, the training algorithms generated using method 225, and the signature data 140 generated using method 200 to generate a prediction output 141. In general, the prediction output 141 may indicate a prediction as to whether an incident may occur in the future at the RAN 102. In an embodiment, the prediction output 141 may include the predicted incident 143, the predicted time period 145, and the preventative resolution 149. As should be appreciated, the prediction output 141 may include other data related to the predicted incident 143 and/or the data used by the predictive model 132 to generate the prediction output 141.

In an embodiment, the prediction output 141 may further include a confidence score 256 associated with the predicted incident 143 at the NE. The confidence score 256 may be a value, proportion, or percentage indicating a level of certainty that the predicted incident 143 has been predicted accurately and completely. The prediction application 123 may determine the confidence score 256 based on a history of the predictive model 122 successfully predicting the prior incidents similar to the predicted incident 143 at other NEs in the RAN 102. For example, the prediction application 123 may have successfully predicted prior incidents similar to the predicted incident 143 at other NEs in the RAN 102 within a correct time period several times in the past (e.g., above a threshold number of times in the past). In this case, the confidence score 256 may be based on or proportional to the threshold that has been exceeded. For example, there may be several tiers of thresholds, and as the threshold increases, so may the confidence score 256 (or vice versa). For example, as the number of times the prediction model 122 accurately predicted an incident increase, the confidence score 256 may also increase. In contrast, the prediction application 123 may not have accurately predicted prior incidents similar to the predicted incident 143 at other NEs in the RAN 102, or the time period was inaccurately predicted multiple times in the past. In this case, the confidence score 256 may be lower and proportional to that threshold that has been exceeded.

In some cases, when the confidence score 256 is above a preset threshold value, the prediction application 123 may determine that the prediction output 141 indicates that an incident is likely to occur at the NE in the near future. In contrast, when the confidence score 256 is less than or equal to a preset threshold value, the prediction application 123 may determine that the prediction output 141 indicates that an incident is not likely to occur at the NE in the near future.

The prediction application 123 may then use the prediction output 141 to generate a service report 151 when the prediction output 141 indicates a predicted incident 143 is likely to occur at the NE in the near future. However, when the prediction output 141 does not indicate that a predicted incident 143 is likely to occur at the NE in the near future, the current radio access data 253 may indicate that the NE is operating normally and actively as expected. In this case, a service report 151 is not generated.

Turning now specifically to FIG. 2D, shown is a block diagram illustrating a method 270 of updating the predictive model 122 to predict incidents before the incident actually occurs in the RAN 102 based on feedback data 154. The validation application 125 may obtain feedback data 154 from various different sources, in which the feedback data 154 includes information that may be used to access a performance of the predictive model 122 and guide improvements to the predictive model 122. In some cases, the feedback data 154 may be information received from other systems, applications, or individuals regarding an accuracy of the prediction output 141 generated by the predictive model 122.

For example, the feedback data 154 may be information received from an automated system that performed the steps indicated in the preventative resolution 149 of the prediction output 141. The automated system may transmit a message to the validation application 125 indicating whether the preventative resolution 149 in fact prevented the predicted incident 143 from occurring at the NE or whether the preventative resolution 149 failed to prevent the predicted incident 143 from occurring at the NE. Alternatively, a NOC operator or a maintenance technician may provide feedback data 154 to the validation application 125 in the form of a message indicating whether the predicted time period 146 was correct in that the predicted incident 143 occurred within the predicted time period 146 or whether the predicted time period 146 was incorrect in that the predicted incident 143 occurred outside the predicted time period.

To this end, a test application in the system may, for example, test the prediction output 141 or in particular, test the accuracy of the prediction output 141 by instructing the system to deliberately refrain from performing the steps of the preventative resolution 149, to detect whether the predicted incident 143 would actually occur without intervention. In this case, the test application may transmit feedback data 154 in the form of a message to the validation application 125 indicating whether the predicted incident 143 would have actually occurred if a preventative measure was not taken. The test application may be used to test other data within the prediction output 141 as well.

The validation application 125 may then input the feedback data 154 into the predictive model 122 to perform an update 275 on the algorithms, computations, and/or data points of the predictive model 122 based on the feedback data 154. The predictive model 122 may also use the feedback data 154 to perform an update 277 on the signature data 140 if applicable (e.g., to indicate that certain data is no longer a signature feature indicating the likelihood of a future incident at the NE, or to indicate that certain data is now being added as a signature feature indicating the likelihood of a future incident at the NE).

Turning now specifically to FIG. 2E, shown is a block diagram illustrating another method 290 of updating the predictive model 122 to predict incidents before the incident actually occurs in the RAN 102 based on updates to data that may be used to train the predictive model 122. The prediction application 123 may obtain updated RAN and incident data 292 describing the RAN 102, the state or configuration of the NEs within the RAN 102, new alarms programmed at the NEs within the RAN 102, new incident reports generated by the incident reporting application 118, triaged/processed by the incident management application 115, and resolved by a NOC operator, field technician or automated system, etc.

The updated RAN and incident 292 may be, for example, detected or monitored by the prediction application 123 or transmitted to the data store 130 by the respective NEs. In either case, the updated RAN and incident data 292 may then be stored at the data store 130 for access by the validation application 125.

The validation application 125 may then input the updated RAN and incident data 292 into the predictive model 122 to perform an update 294 on the algorithms, computations, and/or data points of the predictive model 122 based on the updated RAN and incident data 292. The predictive model 122 may also use the updated RAN and incident data 292 to perform an update 296 on the signature data 140 if applicable (e.g., to indicate that certain data is no longer a signature feature indicating the likelihood of a future incident at the NE, or to indicate that certain data is now being added as a signature feature indicating the likelihood of a future incident at the NE).

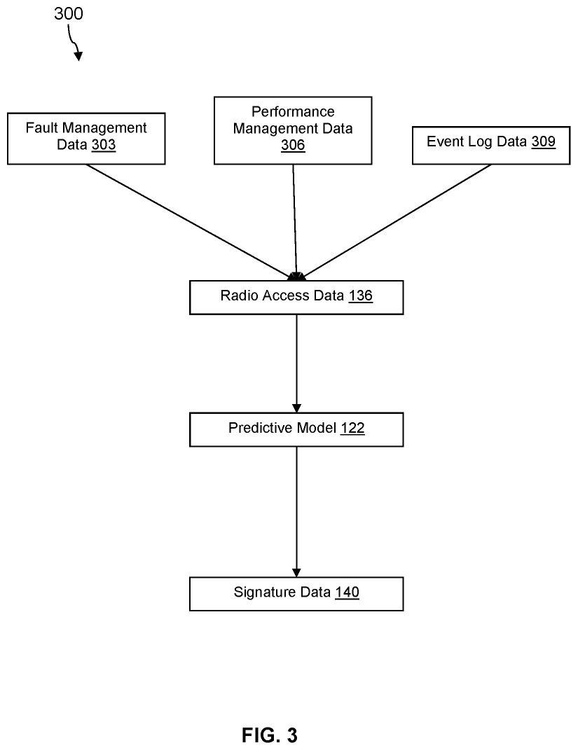

Referring now to FIG. 3, a block diagram illustrating an example method 300 of generating signature data 140 using the predictive model 122 is described. In the example method 300 of FIG. 3, the radio access data 136 is shown as including fault management data 303, performance data 306, and event log data 309. Examples of each of these types of data 303, 306, and 309 are described above with reference to FIG. 1. Each of these types of data 303, 306, and 309 may refer to different types of data that are cross-correlated by the predictive model 122 for the purpose of predicting patterns and trends between the three types of data 303, 306, and 309 as they relate to prior incidents occurring within the RAN 102.

The radio access data 136 may be provided as input into the predictive model 122, which may be configured to perform cross-correlation between the three different types of data 303, 306, and 309 to predict patterns and trends between the three different types of data 303, 306, and 309. For example, fault management data 303 related to warning alarms across NEs that may not have otherwise been processed by the system may be considered by the predictive model 122, in conjunction with performance data 306 associated with those NEs at a similar time, and/or event log data 309 detailing actions performed by those NEs at a similar time. As such, thousands if not millions of different data points across different categories of data may collectively be analyzed together for the purpose of identifying signature features of the NEs that may have triggered the warning alarm (which might ultimately have led to a major alarm or critical alarm if left untreated).

By cross-correlating such a vast amount of data in a relatively fast time period using the predictive model 122, the embodiments disclosed herein are enabled to identify patterns and trends to generate the signature data 140 across the three different types of data 303, 306, and 309 in a significantly more efficient and cost-effective manner. The signature data 140 generated using the predictive model 122 may also be far more accurate than similar computations that may have been performed on a smaller scale in a less automated manner. In this way, the embodiments disclosed herein enable the processing of millions of data points using a predictive machine learning model that may preserve computing and network resources that would have otherwise been used to reactively resolve incidents in the RAN 102.

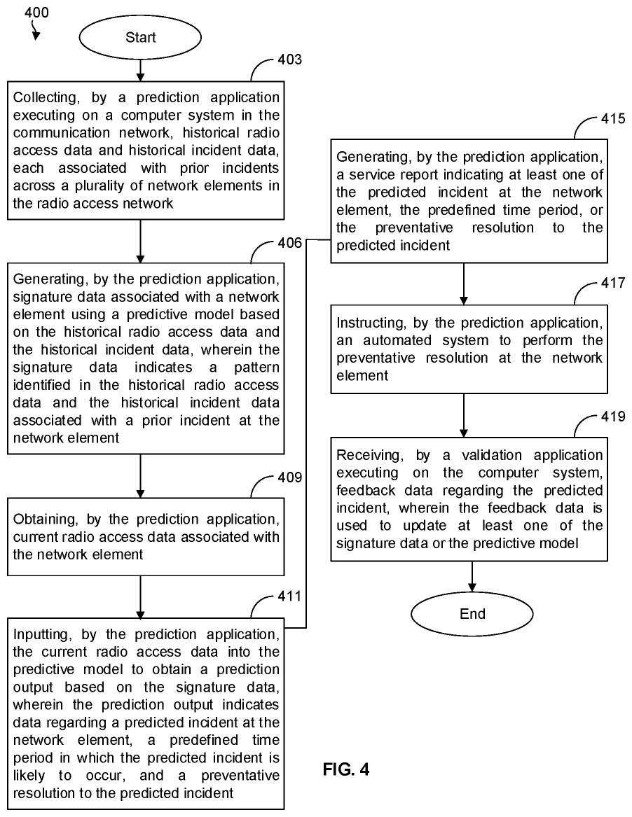

Turning now to FIG. 4, a method 400 is described. In an embodiment, method 400 may be a method for preventing incidents from occurring at the RAN. Method 400 may be performed by the prediction application 123 and the validation application 125 using the predictive model 122.

At step 403, method 400 may comprise collecting, by a prediction application 123 executing on a computer system in the communication network 100, historical radio access data 136 and historical incident data 139, each associated with prior incidents across a plurality of NEs in the RAN 102. At step 406, method 400 may comprise generating, by the prediction application 123, signature data 140 associated with a NE using a predictive model 122 based on the historical radio access data 136 and the historical incident data 139. The signature data 140 may indicate a pattern identified in the historical radio access data 136 and the historical incident data 139 associated with a prior incident at the NE.

At step 409, method 400 may comprise obtaining, by the prediction application 123, current radio access data 253 associated with the NE. At step 411, method 400 may comprise inputting, by the prediction application 123, the current radio access data 253 into the predictive model 122 to obtain a prediction output 141 based on the signature data 140. The prediction output 141 may indicate data regarding a predicted incident 143 at the NE, a predefined time period 146 in which the predicted incident 143 is likely to occur, and a preventative resolution 149 to the predicted incident 143.

At step 415, method 400 may comprise generating, by the prediction application 123, a service report 151 indicating at least one of the predicted incidents 143 at the NE, the predefined time period 146, or the preventative resolution 149 to the predicted incident 143. At step 417, method 400 may comprise instructing, by the prediction application 123, an automated system to perform the preventative resolution 149 at the NE. At step 419, method 400 may comprise receiving, by a validation application 125 executing on the computer system, feedback data 154 regarding the predicted incident 143, in which the feedback data 154 may be used to update at least one of the signature data 160 or the predictive model 122.

Method 400 may comprise other attributes and steps not otherwise shown in the flowchart of FIG. 4. In an embodiment, the historical incident data 139 may indicate a prior resolution of the prior incident at the NE, the historical radio access data 136 may comprise at least one of fault management data indicating one or more alarms triggered at the NE at a time of the prior incident at the NE, performance data indicating one or more counts associated with a performance of the NE at the time of the prior incident at the NE, or event logs associated with one or more events occurring at the NE at the time of the prior incident at the NE. In an embodiment, the current radio access data 253 may comprise fault management data indicating a minor alarm triggered at the NE and performance data indicating a dropped call count at the NE. In an embodiment, the signature data 140 may be based on correlations identified between different types of the historical radio access data 136 and the historical incident data 139 associated with the prior incident at the NE. In an embodiment, the prediction output 141 further comprises a confidence score 256 associated with the predicted incident 143 at the NE, in which the confidence score 256 indicates a level of certainty of an accuracy regarding the predicted incident 143 and is based on a history of the predictive model 122 successfully predicting similar incidents at one or more other NEs in the RAN 102. In an embodiment, method 400 may further comprise storing, by the prediction application 123, the service report 151 in a data store 130 of the communication network 100. In an embodiment, the preventative resolution 149 may comprise one or more corrective actions to be taken in association with the NE to prevent the predicted incident 143. In an embodiment, the feedback data 154 may indicate an accuracy of the prediction output 141, and method 400 may further comprise updating, by the validation application 125, the predictive model 122 based on the feedback data 154. In an embodiment, method 400 may further comprise updating, by the validation application 125, at least one of the signature data 140 and the predictive model 122 based on updated RAN and incident 292 describing the RAN 102.

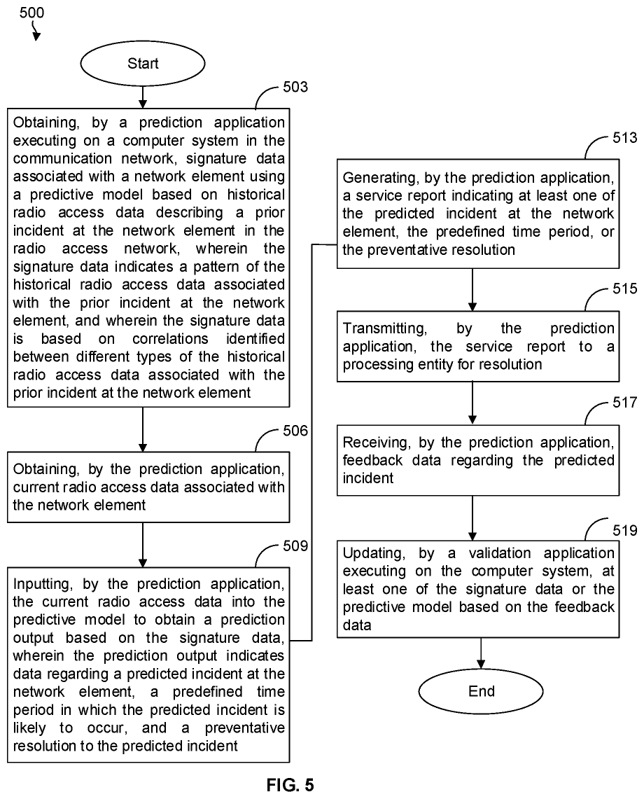

Turning now to FIG. 5, a method 500 is described. In an embodiment, method 500 may be a method for preventing incidents from occurring at the RAN. Method 500 may be performed by the prediction application 123 and the validation application 125 using the predictive model 122.

At step 503, method 500 may comprise obtaining, by a prediction application 123 executing on a computer system in the communication network 100, signature data 140 associated with a NE using a predictive model 122 based on historical radio access data 136 describing a prior incident at a NE in the RAN 102. The signature data 140 may indicate a pattern of the historical radio access data 136 associated with the prior incident at the NE, and the signature data 140 may be based on correlations identified between different types of the historical radio access data 136 associated with the prior incident at the NE.

At step 506, method 500 may comprise obtaining, by the prediction application 123, current radio access data 253 associated with the NE. At step 509, method 500 may comprise inputting, by the prediction application 123, the current radio access data 253 into the predictive model 122 to obtain a prediction output 141 based on the signature data 140, in which the prediction output 141 may indicate data regarding a predicted incident 143 at the NE, a predefined time period 146 which the predicted incident 143 is likely to occur, and a preventative resolution 149 to the predicted incident 143.

At step 513, method 500 may comprise generating, by the prediction application 123, a service report 151 indicating at least one of the predicted incidents 143 at the NE, the predefined time period 146, or the preventative resolution 149. At step 515, method 500 may comprise transmitting, by the prediction application 123, the service report 151 to a processing entity for resolution. At step 517, method 500 may comprise receiving, by the prediction application 123, feedback data 154 regarding the predicted incident 143. At step 519, method 500 may comprise updating, by the prediction application 123, at least one of the signature data 140 or the predictive model 122 based on the feedback data 154.

Method 500 may comprise other attributes and steps not otherwise shown in the flowchart of FIG. 5. In an embodiment, method 500 may further comprise updating, by the validation application 125, at least one of the signature data 140 or the predictive model 122 based on updated radio access data 182 describing updates to the RAN 102. In an embodiment, the feedback data may indicate an accuracy of the prediction output 141, and method 400 may further comprise updating, by the validation application 125, the predictive model 122 based on the feedback data 154. In an embodiment, the prediction output 141 may further comprise a confidence score 256 associated with the predicted incident 143 at the NE, in which the confidence score 256 may indicate a level of certainty regarding the predicted incident 143 and may be based on a history of the predictive model 122 successfully predicting the predicting incident 143 at one or more other NEs in the RAN 102. In an embodiment, the processing entity is a network operations center (NOC) operator, a field technician, or an automated system. In an embodiment, the current radio access data 253 may comprises fault management data indicating a warning alarm triggered at NE and performance data indicating a degrading performance count at the NE.

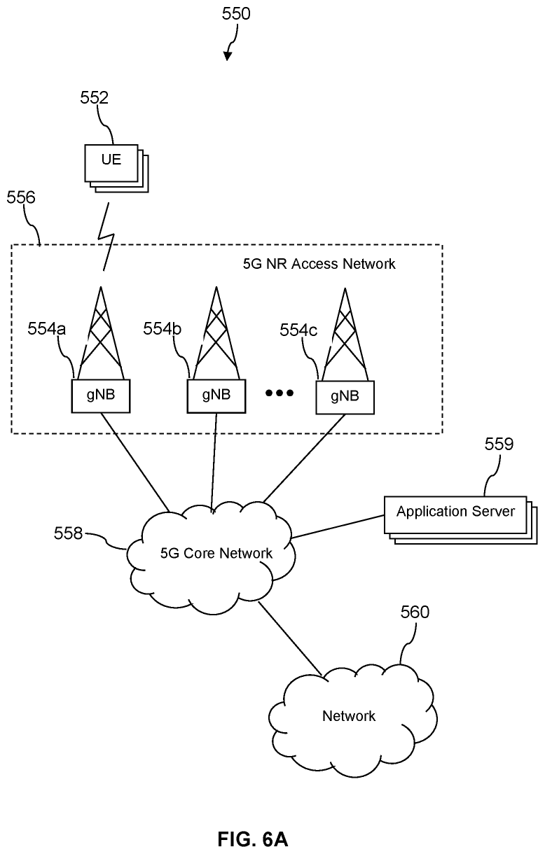

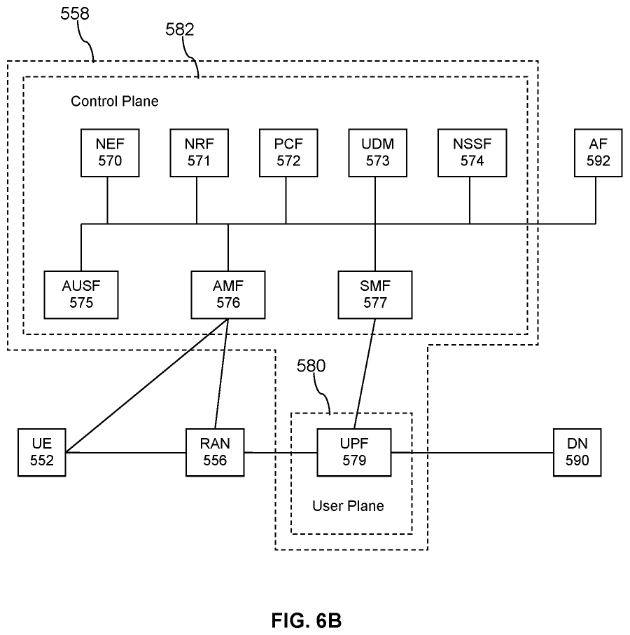

Turning now to FIG. 6A, an exemplary communication system 550 is described, similar to the communication network 100. Typically, the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a radio access network (RAN) in some contexts. In a 5G technology generation an access node 554 may be referred to as a next Generation Node B (gNB). In 4G technology (e.g., long term evolution (LTE) technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as Long Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 6B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 6A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be executed on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

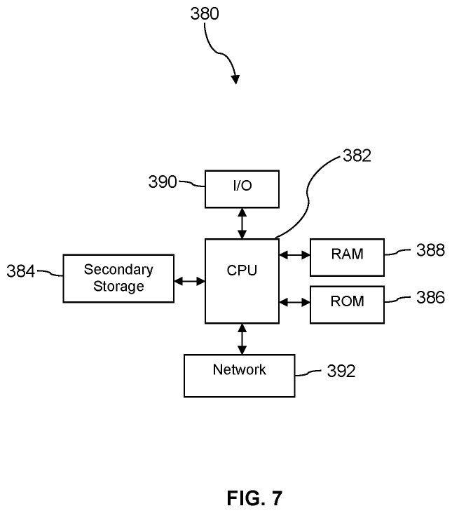

FIG. 7 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for maintaining a communication network by predicting incidents in a radio access network of the communication network, wherein the method comprises:
obtaining, by a prediction application executing on a computer system in the communication network, signature data associated with a network element using a predictive model based on historical radio access data describing a prior incident at the network element in the radio access network, wherein the signature data indicates a pattern of the historical radio access data associated with the prior incident at the network element, and wherein the signature data is based on correlations identified between different types of the historical radio access data associated with the prior incident at the network element;
obtaining, by the prediction application, current radio access data associated with the network element;
inputting, by the prediction application, the current radio access data into the predictive model to obtain a prediction output based on the signature data, wherein the prediction output indicates data regarding a predicted incident at the network element, a predefined time period in which the predicted incident is likely to occur, and a preventative resolution to the predicted incident, wherein the preventative resolution comprises one or more corrective actions to prevent the predicted incident from occurring;
generating, by the prediction application, a service report indicating at least one of the predicted incidents at the network element, the predefined time period, or the preventative resolution;
transmitting, by the prediction application, the service report to a processing entity for resolution;
receiving, by the prediction application, feedback data regarding the predicted incident; and
updating, by a validation application executing on the computer system, at least one of the signature data or the predictive model based on the feedback data.

2. The method of claim 1, further comprising updating, by the validation application, at least one of the signature data or the predictive model based on updated radio access data describing the radio access network.

3. The method of claim 1, wherein the feedback data indicates an accuracy of the prediction output, and wherein the method further comprises updating, by the validation application, the predictive model based on the feedback data.

4. The method of claim 1, wherein the prediction output further comprises a confidence score associated with the predicted incident at the network element, wherein the confidence score indicates a level of certainty regarding the predicted incident and is based on a history of the predictive model successfully predicting the predicting incident at one or more other network elements in the radio access network.

5. The method of claim 1, wherein the processing entity is a network operations center (NOC) operator, a field technician, or an automated system.

6. The method of claim 1, wherein the current radio access data comprises fault management data indicating a warning alarm triggered at the network element and performance data indicating a degrading performance count at the network element.

7. A communications network implemented in a network comprising a radio access network, wherein the communications network comprises:
a prediction application executing on a computer system in the communication network, wherein the prediction application is configured to:
use a predictive model to obtain signature data associated with a network element based on a historical radio access data describing a prior incident at the network element in the radio access network, wherein the signature data indicates a pattern of the historical radio access data associated with the prior incident at the network element, and wherein the signature data is based on correlations identified between different types of the historical radio access data associated with the prior incident at the network element;
obtain current radio access data associated with the network element;
input the current radio access data into the predictive model to obtain a prediction output based on the signature data, wherein the prediction output indicates data regarding a predicted incident at the network element, a predefined time period during which the predicted incident is likely to occur, and a preventative resolution to the predicted incident;
generate a service report indicating at least one of the predicted incidents at the network element, the predefined time period, or the preventative resolution; and
transmit the service report to a processing entity for resolution; and
a validation application executing on the computer system, wherein the validation application is configured to update at least one of the signature data or the predictive model based on feedback data describing an accuracy of the prediction output.

8. The communications network of claim 7, wherein the validation application is further configured to update at least one of the signature data and the predictive model based on updated radio access data describing the radio access network.

9. The communications network of claim 7, wherein the validation application is further configured to input the feedback data into the predictive model to update at least one of the signature data or the predictive model based on the feedback data.

10. The communications network of claim 7, wherein the prediction output further comprises a confidence score associated with the predicted incident at the network element, wherein the confidence score indicates a level of certainty regarding the predicted incident and is based on a history of the predictive model successfully predicting the predicting incident at one or more other network elements in the radio access network.

11. The communications network of claim 7, wherein the current radio access data comprises fault management data indicating a warning alarm triggered at the network element and performance data indicating an abnormal performance count at the network element.

12. A method for maintaining a communication network, wherein the method comprises:
collecting, by a prediction application executing on a computer system in the communication network, historical radio access data and historical incident data, each associated with prior incidents across a plurality of network elements in the radio access network;
generating, by the prediction application, signature data associated with a network element using a predictive model based on the historical radio access data and the historical incident data, wherein the signature data indicates a pattern identified in the historical radio access data and the historical incident data associated with a prior incident at the network element;
obtaining, by the prediction application, current radio access data associated with the network element;
inputting, by the prediction application, the current radio access data into the predictive model to obtain a prediction output based on the signature data, wherein the prediction output indicates data regarding a predicted incident at the network element, a predefined time period in which the predicted incident is likely to occur, and a preventative resolution to the predicted incident;
generating, by the prediction application, a service report indicating at least one of the predicted incident at the network element, the predefined time period, or the preventative resolution to the predicted incident;
instructing, by the prediction application, an automated system to perform the preventative resolution at the network element; and
receiving, by a validation application executing on the computer system, feedback data regarding the predicted incident, wherein the feedback data is used to update at least one of the signature data or the predictive model.

13. The method of claim 12, wherein the historical incident data indicates a prior resolution of the prior incident at the network element, wherein the historical radio access data comprise at least one of fault management data indicating one or more alarms triggered at the network element at a time of the prior incident at the network element, performance data indicating one or more counts associated with a performance of the network element at the time of the prior incident at the network element, or event logs associated with one or more events occurring at the network element at the time of the prior incident at the network element.

14. The method of claim 12, wherein the current radio access data comprises fault management data indicating a minor alarm triggered at the network element and performance data indicating a dropped call count at the network element.

15. The method of claim 12, wherein the signature data is based on correlations identified between different types of the historical radio access data and the historical incident data associated with the prior incident at the network element.

16. The method of claim 12, wherein the prediction output further comprises a confidence score associated with the predicted incident at the network element, wherein the confidence score indicates a level of certainty of an accuracy regarding the predicted incident and is based on a history of the predictive model successfully predicting similar incidents at one or more other network elements in the radio access network.

17. The method of claim 12, further comprising storing, by the prediction application, the service report in a data store of the communication network.

18. The method of claim 12, wherein the preventative resolution comprises one or more corrective actions to be taken in association with the network element to prevent the predicted incident.

19. The method of claim 12, wherein the feedback data indicates an accuracy of the prediction output, and wherein the method further comprises updating, by the validation application, the predictive model based on the feedback data.

20. The method of claim 12, further comprising updating, by the validation application, at least one of the signature data and the predictive model based on updated radio access data describing the radio access network.
